(19) United States
(12) Patent Application Publication
(10) Pub. No.: US 2026/0155079 A1
(43) Pub. Date: Jun. 4, 2026

(54) DISPLAY DEVICE

(71) Applicant: Sharp Display Technology Corporation, Kameyama City, Mie (JP)

(72) Inventors: Tatsuhiko SUYAMA, Kameyama City, Mie (JP); Yoshitaka ORITA, Kameyama City, Mie (JP); Shunsuke NOICHI, Kameyama City, Mie (JP); Koki YAMAMOTO, Kameyama City, Mie (JP)

(21) Appl. No.: 18/724,205

(22) PCT Filed: Feb. 28, 2022
(86) PCT No.: PCT/JP2022/008346

§ 371 Date: Jun. 26, 2024

(51) Int. Cl. G09G 3/20; G09G 3/32

(52) U.S. Cl. CPC G09G 3/2074; G09G 3/32; G09G 2320/0233; G09G 2320/0242; G09G 2320/043; G09G 2320/0666; G09G 2360/16

(57) ABSTRACT

A display device includes the following: a first section in which a predetermined low grayscale is displayed during a period of video display on a display unit, and a second section in which a predetermined high grayscale is displayed during the period of video display on the display unit. A control unit corrects deterioration compensation data in accordance with a result of a comparison between a first reference display with a first reference grayscale displayed in the first section, and a sample display with at least one sample grayscale displayed in the second section.

### TECHNICAL FIELD

The present invention relates to a display device.

### BACKGROUND ART

Patent Literature 1 discloses a method for compensating deterioration of an organic light-emitting display device, that includes detecting a deteriorated region in its display region, and generating compensation data by using sensing data of the deteriorated region.

### CITATION LIST

### Patent Literature

Patent Literature 1: Japanese Unexamined Patent Application Publication No. 2018-84811

### SUMMARY OF INVENTION

### Technical Field

The technique in Patent Literature 1, which requires sensing the state of deterioration at each site of the display region, unfortunately complicates the configuration of the display device.

### Solution to Problem

A display device according to one aspect of the present invention is a display device provided with a display unit including a plurality of subpixels, and a control unit configured to generate output data in accordance with input data and deterioration compensation data. The display device includes the following: a first section in which a predetermined low grayscale is displayed or hidden during a period of video display on the display unit; and a second section in which a predetermined high grayscale is displayed during the period of video display on the display unit. The control unit corrects the deterioration compensation data in accordance with a result of a comparison between a first reference display with a first reference grayscale displayed in the first section, and a sample display with at least one sample grayscale displayed in the second section.

### Advantageous Effect of Invention

One aspect of the present invention simplifies the configuration of a display device.

### BRIEF DESCRIPTION OF DRAWINGS

FIG. 1 is a block diagram illustrating the configuration of a display device according to the present disclosure.

FIG. 2 is a graph showing the relationship between an output grayscale indicated by output data and the luminance of a subpixel.

FIG. 3 is a block diagram illustrating the operation of the display device according to the present disclosure.

FIG. 4 is a graph showing an example of deterioration compensation data.

FIG. 5 is a flowchart showing a function of verifying the deterioration compensation data in a control unit.

FIG. 6 is a schematic diagram illustrating an example of a comparison between a reference display and a sample display.

FIG. 7 is a graph showing an example of correction of the deterioration compensation data.

FIG. 8 is a schematic diagram illustrating a display state of a display unit according to a first embodiment.

FIG. 9 is a flowchart showing a process for verifying deterioration compensation data for each of emission colors of subpixels.

FIG. 10 is a table showing a combination of a reference grayscale and optimal sample grayscale for each of the emission colors of the subpixels.

FIG. 11 is a graph showing an example of correction of the deterioration compensation data for each emission color.

FIG. 12 is a flowchart showing a process for verifying deterioration compensation data for each of a plurality of grayscales indicated by input data.

FIG. 13 is a table showing an optimal sample grayscale for each of a plurality of reference grayscales.

FIG. 14 is a graph showing an example of correction of the deterioration compensation data.

FIG. 15 is a schematic diagram illustrating the display device according to a fourth embodiment.

FIG. 16 is a side view of the configuration of the display device according to a fifth embodiment.

FIG. 17 is a schematic diagram illustrating the configuration of a first section according to a sixth embodiment, and the configuration of a second section according to the sixth embodiment.

### DESCRIPTION OF EMBODIMENTS

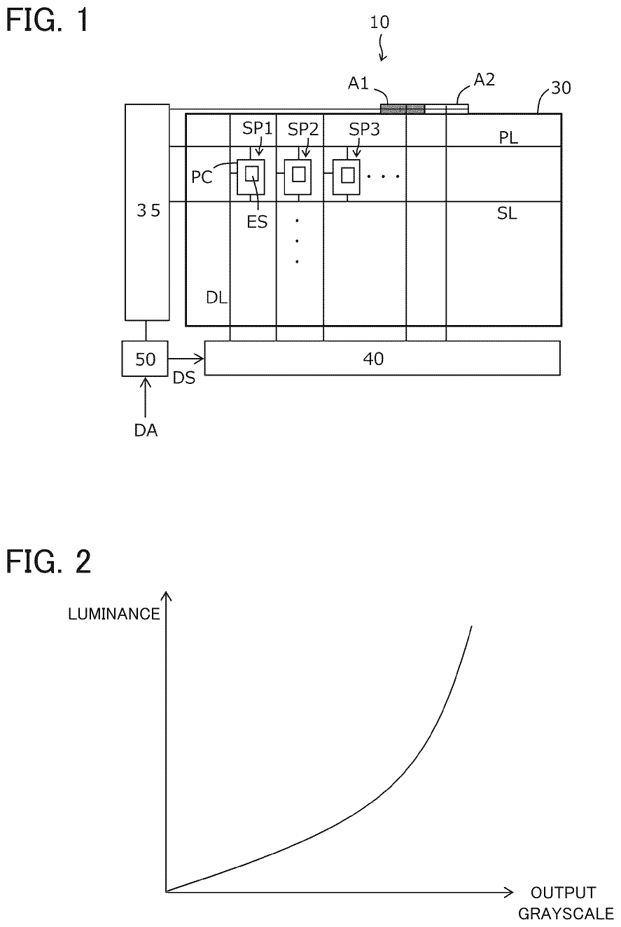

FIG. 1 is a block diagram illustrating the configuration of a display device according to the present disclosure. As illustrated in FIG. 1, the display device, 10, is provided with a display unit 30, a drive unit 40 (driver circuit), and a control unit 50 that controls the drive unit 40. The display unit 30 includes a plurality of subpixels SP1, SP2, and SP3. The control unit 50 may include a processor and a memory. The control unit 50 generates output data DS, and by using the output data DS, a scanning-signal-line driving circuit 35 and the data-signal-line driving circuit 40 drive the plurality of subpixels SP1, SP2, and SP3. Each subpixel includes a light-emitting element ES, and a pixel circuit PC connected to the light-emitting element ES. The pixel circuit PC is composed of a write transistor, a drive transistor, and a capacitive element, for instance and is connected to a data signal line DL, a scanning signal line SL, and a power supply wire PL (e.g., an ELVDD wire).

The subpixel SP1 is a subpixel that emits light of a first color, the subpixel SP2 is a subpixel that emits light of a second color, and the subpixel SP3 is a subpixel that emits light of a third color. One of the first to third colors may be red, one of the remaining two colors may be green, and the other may be blue. The term “subpixel” simply indicates any one of the subpixels SP1, SP2, and SP3. Usable examples of the light-emitting element ES include a light-emitting diode including an organic light-emitting layer, and a light-emitting diode including a quantum-dot light-emitting layer. FIG. 2 is a graph showing the relationship between an output grayscale indicated by the output data and the luminance of the subpixel. The graph in FIG. 2 is a curve based on gamma 2.2 for instance.

### First Embodiment

As illustrated in FIG. 1, the display device 10 is provided with the following outside the perimeter of the display unit 30: a first section A1 including a plurality of subpixels (for instance, of the same structure as the subpixels SP1, SP2, and SP3 of the display unit 30); and a second section A2 including a plurality of subpixels (for instance, of the same structure as the subpixels SP1, SP2, and SP3 of the display unit 30). The first section A1 and the second section A2 may be adjacent to the display unit 30.

The first section A1 and the second section A2 may be adjacent to each other. The first section A1 and the second section A2 may be rectangular (e.g., oblong). The display unit 30, the first section A1, and the second section A2 may be formed on an identical pixel circuit substrate (e.g., a TFT substrate).

In the first section A1, a fixed display at a predetermined low grayscale (a dark static-image display) is presented during a period of video display on the display unit 30, and in the second section A2, a fixed display at a predetermined high grayscale (a bright static-image display) is presented during the period of video display on the display unit 30. The predetermined low grayscale can be a minimum grayscale (black grayscale), and the predetermined high grayscale can be a maximum grayscale (white grayscale). That is, the first section A1 has a smaller deterioration degree than any of the subpixels in the display unit 30, and the second section A2 has a larger deterioration degree than any of the subpixels in the display unit 30.

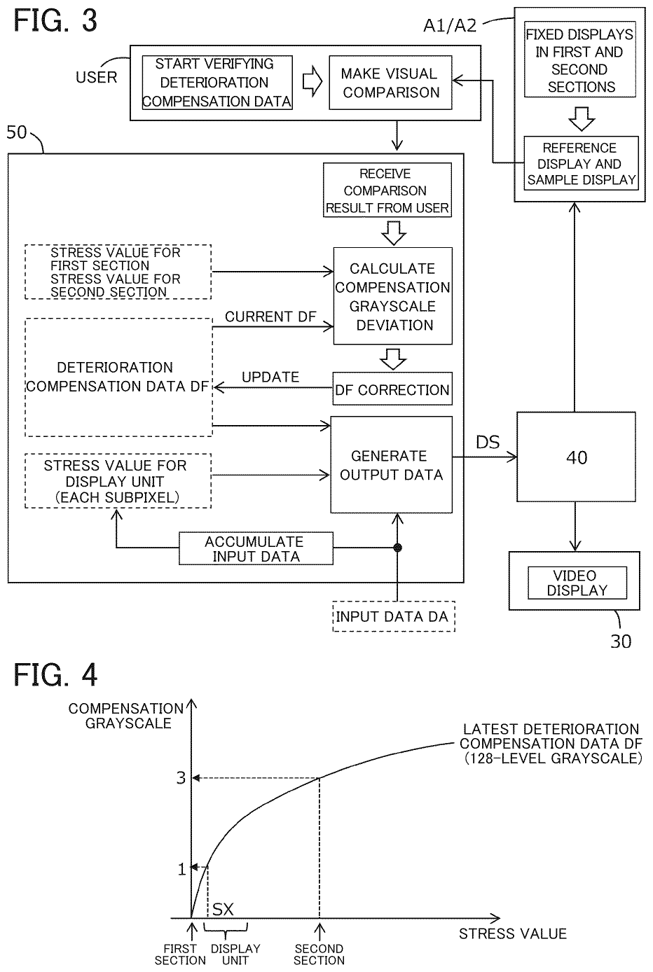

FIG. 3 is a block diagram illustrating the operation of the display device according to the present disclosure. FIG. 4 is a graph showing an example of deterioration compensation data. The control unit 50 stores a stress value for the first section A1, a stress value for the second section A2, a stress value for the display unit 30 (each subpixel), and deterioration compensation data DF.

A stress value is an index that indicates a cumulative load on a subpixel, and that is calculated in accordance with a display history (emission luminance and emission time). The deterioration degree of the subpixel increases along with increase in the stress value. The stress value for the display unit 30 is larger than the stress value for the first section A1 and is smaller than the stress value for the second section A2. The stress value for the display unit 30 can be calculated using an accumulation of input data or output data in each subpixel.

The deterioration compensation data DF is data for associating a stress value with a compensation grayscale for each input grayscale (e.g., 0- to 255-level grayscale) indicated by input data DA. FIG. 4 shows, by way of example, the deterioration compensation data DF in 128-level input grayscale. In 0-level input grayscale (non-lighting), the compensation grayscale stands at zero irrespective of the stress value.

The control unit 50 verifies the deterioration compensation data DF. That is, the control unit 50 corrects the deterioration compensation data DF in accordance with the result of a comparison between a first reference display with a first reference grayscale displayed in the first section A1, and a sample display with at least one sample grayscale displayed in the second section A2. To be specific, the control unit 50 receives the result of the comparison from a user, followed by calculating a compensation grayscale deviation in accordance with the result of the comparison, to correct and update the deterioration compensation data DF in accordance with the compensation grayscale deviation (which will be described later on).

The control unit 50 generates the output data DS in accordance with the input grayscale indicated by the input data DA, and in accordance with the (latest) deterioration compensation data DF. The output data DS is calculated using the input grayscale, and a compensation grayscale corresponding to the input grayscale. For instance, when a certain subpixel (the stress value at the moment is SX) in the display unit 30 has 128-level input grayscale, the compensation grayscale is 1-level grayscale, as shown in FIG. 4; thus, the output data DS has 129-level grayscale (128-level grayscale plus 1-level grayscale). The output data DS is output to the data-signal-line driving circuit 40. FIG. 2 shows, by way of example, the relationship between an output grayscale indicated by the output data DS, and the luminance of a subpixel in the display unit 30.

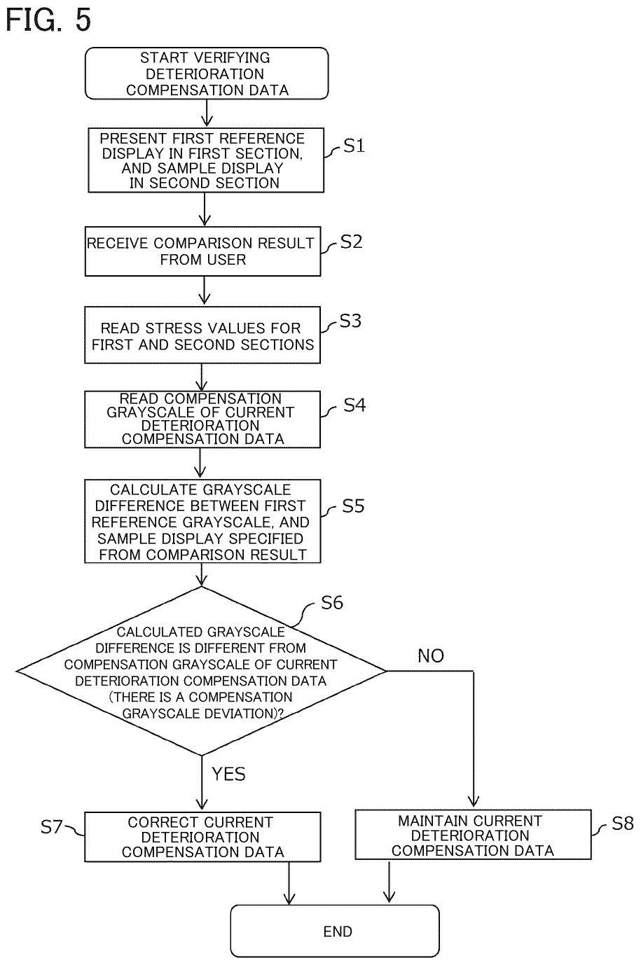

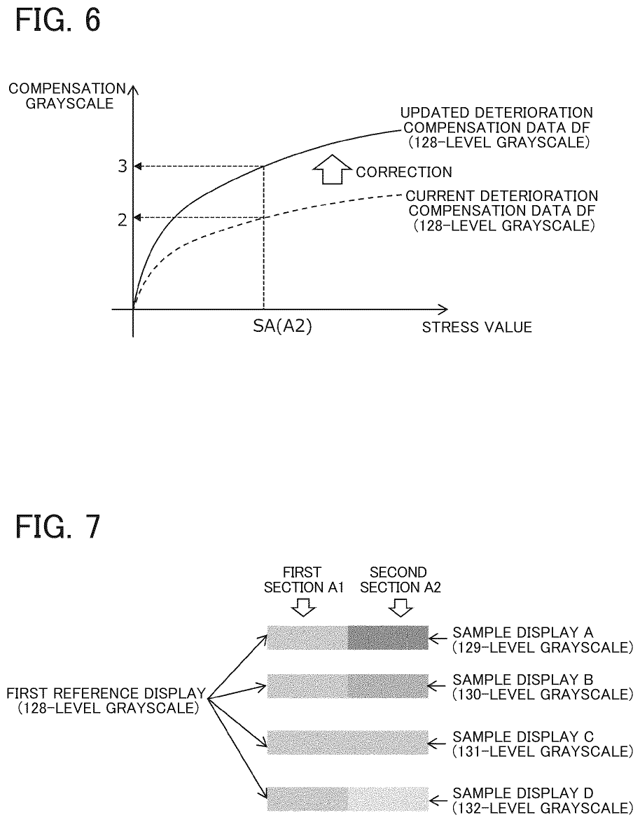

FIG. 5 is a flowchart showing a function of verifying the deterioration compensation data in the control unit. FIG. 6 is a graph showing an example of correction of the deterioration compensation data. As shown in FIG. 5, Step S1 is presenting a first reference display, with a first reference grayscale displayed in the first section A1, and a sample display in the second section A2. The first reference grayscale may be a grayscale near the middle grayscale (e.g., 128-level grayscale) among all input grayscales (e.g., 0- to 255-level grayscale) that can be indicated by input data. Step S2 is user's input of the result of a comparison.

Step S3 is reading stress values for the first section A1 and second section A2. Step S4 is reading a compensation grayscale of the current deterioration compensation data DF (FIG. 6).

Step S5 is calculating a grayscale difference between the first reference grayscale and the sample grayscale specified in the result of the comparison. Step S6 is determining whether the grayscale difference calculated in Step S5 is different from the compensation grayscale corresponding to a stress value SA of the current deterioration compensation data FD in FIG. 6 (whether there is a compensation grayscale deviation); here, the stress value for the second section A2 is defined as SA (it may be a relative value corresponding to the stress value for the first section A1).

If YES in Step S6 (if the grayscale difference obtained from the result of the comparison and the compensation grayscale=2 in FIG. 6 are different), the process proceeds to Step S7 to correct (update) the current deterioration compensation data DF. If NO in Step S6 (if the grayscale difference obtained from the result of the comparison and the compensation grayscale=2 in FIG. 6 are equal), the process proceeds to Step S8 to maintain the current deterioration compensation data DF. It is noted that FIG. 4 illustrates the deterioration compensation data DF (with 128-level grayscale) in FIG. 6 after update.

To prevent deterioration of the first section A1, the individual subpixels in the first section A1 do not have to be driven (may be hidden) during the period of video display on the display unit 30 (all periods but a period for Step S1 in FIG. 5). The deterioration compensation data may be verified at the time of a periodical inspection (of a vehicle or other things) or may be verified by the user freely. The user may be periodically notified of a recommendation of FD verification.

FIG. 7 is a schematic diagram illustrating an example of a comparison between a reference display and a sample display. FIG. 7 is a graph showing an example of correction of the deterioration compensation data. In Steps S1 and S2 in FIG. 5, a plurality of sample displays (sample displays A through D) are presented in the second section A2, which is adjacent to the first section A1, with the first reference display (128-level grayscale) displayed in the first section A1, and the user visually decides a sample display C (131-level grayscale), which is the closest to the first reference display. The sample displays A through D are displayed in the form of, for instance, a static image at intervals of several seconds.

The control unit 50 receives an optimal sample grayscale, which is herein 131-level grayscale, as the result of the comparison from the user. In this case, the grayscale difference between the first reference grayscale (128-level grayscale) and the optimal sample grayscale (131-level grayscale) specified from the result of the comparison is “3-level grayscale”, which is different from “2-level grayscale” of the compensation grayscale corresponding to the stress value SA of the current deterioration compensation data FD (DA=128-level grayscale) in FIG. 6; accordingly, the control unit 50 corrects (updates) the whole (correction grayscale for all stress values) of the current deterioration compensation data DF (DA=128-level grayscale), as illustrated in FIG. 6, in such a manner that the compensation grayscale corresponding to the stress value SA becomes “3-level grayscale”.

Since the deterioration compensation data DF is prepared for all input grayscales that can be indicated by the input data DA, the deterioration compensation data DF for another input grayscale may be corrected in accordance with the correction degree of the deterioration compensation data DF of 128-level grayscale. As a matter of course, the deterioration compensation data DF for another input grayscale may be verified and corrected (which will be described later on).

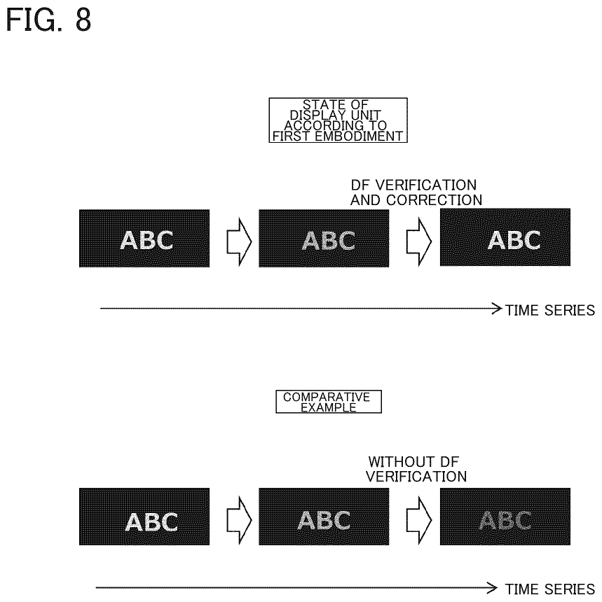

FIG. 8 is a schematic diagram illustrating a display state of the display unit according to the first embodiment. The drawing reveals that the ABC's display luminance is restored to a proper state through verification and correction of the deterioration compensation data even if the ABC's display luminance is reduced by aging degradation. Unlike the conventional methods, there is no need for complicated design change for sensing or other processing. It is noted that no verification of the deterioration compensation data, like the comparative example, further reduces the ABC's display luminance. It is desirable to set a margin in the performance of the driver 40, so that a deterioration can be compensated even if the input data has a maximum grayscale (white grayscale). For instance, when the input data has 255-level grayscale, which is the maximum grayscale, and the output data with the compensation grayscale added has 257-level grayscale, the performance of the driver 40 is set in such a manner as to allow a current corresponding to the 257-level grayscale (a current larger than a current corresponding to the 255-level grayscale) to flow through a light-emitting element.

### Second Embodiment

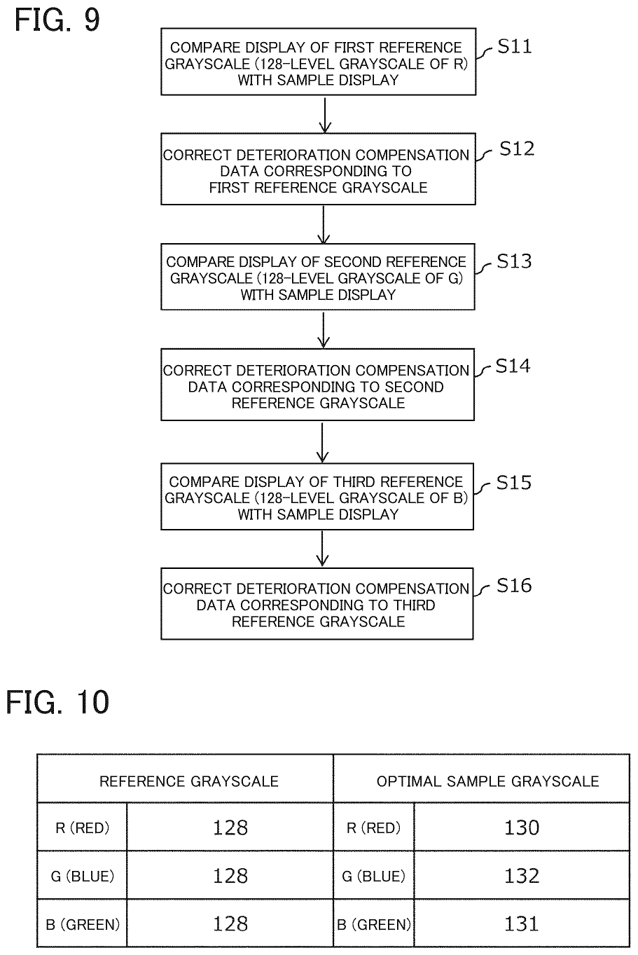

FIG. 9 is a flowchart showing a process for verifying deterioration compensation data for each of emission colors of subpixels. As shown in FIG. 9, Step 11 is comparing a display of a first reference grayscale (128-level grayscale of red) with a sample display in the second section A2 (stress value SA). Step 12 is correcting the whole of the deterioration compensation data (DA=R128-level grayscale) corresponding to the first reference grayscale. Step 13 is comparing a display of a second reference grayscale (128-level grayscale of green) with the sample display in the second section A2 (stress value SA). Step 14 is correcting the whole of the deterioration compensation data (DA=G128-level grayscale) corresponding to the second reference grayscale. Step 15 is comparing a display of a third reference grayscale (128-level grayscale of blue) with the sample display in the second section A2 (stress value SA). Step 16 is correcting the whole of the deterioration compensation data (DA=B128-level grayscale) corresponding to the third reference grayscale.

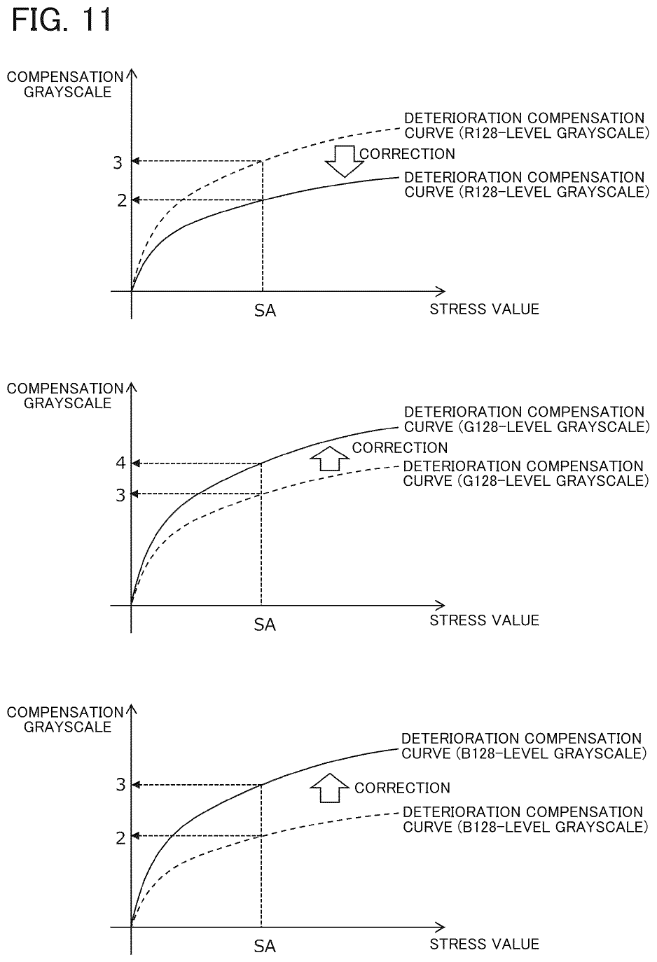

FIG. 10 is a table showing a combination of a reference grayscale and optimal sample grayscale for each of the emission colors of the subpixels. FIG. 11 is a graph showing an example of correction of the deterioration compensation data for each emission color.

In Step S12, the grayscale difference between the first reference grayscale (R128-level grayscale) and the optimal sample grayscale (R130-level grayscale) specified from the result of the comparison is “2-level grayscale”, which is different from “3-level grayscale” of the compensation grayscale corresponding to the stress value SA of the current deterioration compensation data FD (DA=R128-level grayscale) in FIG. 11; accordingly, the control unit 50 corrects (updates) the whole of the current deterioration compensation data DF (DA=R128-level grayscale), as illustrated in FIG. 11, in such a manner that the compensation grayscale corresponding to the stress value SA becomes “2-level grayscale”.

In Step S14, the grayscale difference between the second reference grayscale (G128-level grayscale) and the optimal sample grayscale (G132-level grayscale) specified from the result of the comparison is “4-level grayscale”, which is different from “3-level grayscale” of the compensation grayscale corresponding to the stress value SA of the current deterioration compensation data FD (DA=G128-level grayscale) in FIG. 11; accordingly, the control unit 50 corrects (updates) the whole of the current deterioration compensation data DF (DA=G128-level grayscale), as illustrated in FIG. 11, in such a manner that the compensation grayscale corresponding to the stress value SA becomes “4-level grayscale”.

In Step S16, the grayscale difference between the third reference grayscale (B128-level grayscale) and the optimal sample grayscale (B131-level grayscale) specified from the result of the comparison is “3-level grayscale”, which is different from “2-level grayscale” of the compensation grayscale corresponding to the stress value SA of the current deterioration compensation data FD (DA=B128-level grayscale) in FIG. 11; accordingly, the control unit 50 corrects (updates) the whole of the current deterioration compensation data DF (DA=B128-level grayscale), as illustrated in FIG. 11, in such a manner that the compensation grayscale corresponding to the stress value SA becomes “3-level grayscale”.

### Third Embodiment

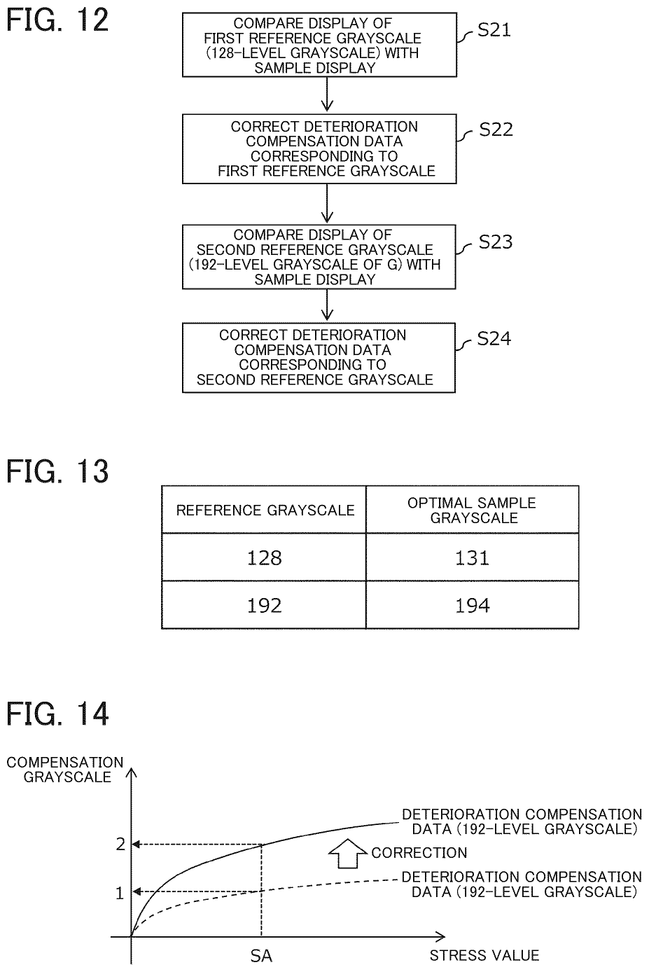

FIG. 12 is a flowchart showing a process for verifying deterioration compensation data for each of a plurality of grayscales indicated by input data. As shown in FIG. 12, Step 21 is comparing a display of a first reference grayscale (128-level grayscale) with a sample display in the second section A2 (stress value SA). Step 22 is correcting the deterioration compensation data (DA=128-level grayscale) corresponding to the first reference grayscale. Step 23 is comparing a display of a second reference grayscale (192-level grayscale) with the sample display in the second section A2 (stress value SA). Step 24 is correcting the deterioration compensation data (DA=192-level grayscale) corresponding to the second reference grayscale.

FIG. 13 is a table showing an optimal sample grayscale for each of a plurality of reference grayscales. FIG. 14 is a graph showing an example of correction of the deterioration compensation data.

In Step S22, the grayscale difference between the first reference grayscale (128-level grayscale) and the optimal sample grayscale (131-level grayscale) specified from the result of the comparison is “3-level grayscale”, which is different from “2-level grayscale” of the compensation grayscale corresponding to the stress value SA of the current deterioration compensation data FD (DA=128-level grayscale) in FIG. 6; accordingly, the control unit 50 corrects (updates) the whole of the current deterioration compensation data DF (DA=128-level grayscale), as illustrated in FIG. 6, in such a manner that the compensation grayscale corresponding to the stress value SA becomes “3-level grayscale”.

In Step S24, the grayscale difference between the second reference grayscale (192-level grayscale) and the optimal sample grayscale (194-level grayscale) specified from the result of the comparison is “2-level grayscale”, which is different from “1-level grayscale” of the compensation grayscale corresponding to the stress value SA of the current deterioration compensation data FD (DA=192-level grayscale) in FIG. 14; accordingly, the control unit 50 corrects (updates) the whole of the current deterioration compensation data DF (DA=192-level grayscale), as illustrated in FIG. 14, in such a manner that the compensation grayscale corresponding to the stress value SA becomes “2-level grayscale”.

Although the deterioration compensation data DF in the third embodiment undergoes verification and update for DA=128-level grayscale and 192-level grayscale, the deterioration compensation data DF desirably undergoes verification for more grayscales. With regard to a grayscale for which the deterioration compensation data DF does not undergo verification, the deterioration compensation data DF can be obtained through complement processing based on the verified deterioration compensation data DF.

### Fourth Embodiment

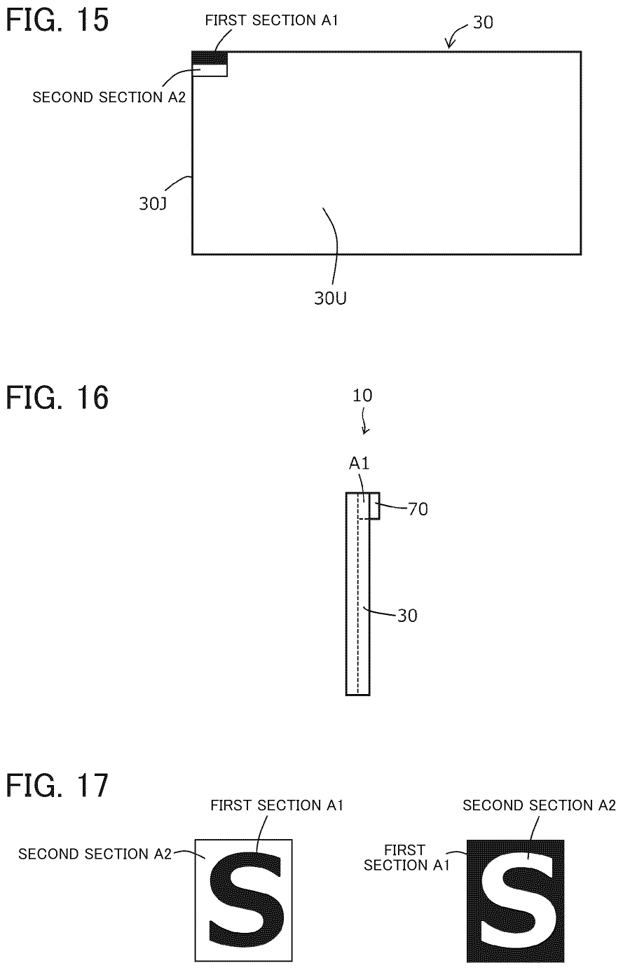

FIG. 15 is a schematic diagram illustrating the display device according to a fourth embodiment. The first section A1 and second section A2 in FIG. 1 are located outside the perimeter of the display unit 30 by way of example. The first section A1 and second section A2 may be located inside the perimeter, 30J, of the display unit 30, as illustrated in FIG. 15. In this case, the first section A1 has a smaller deterioration degree than any of the subpixels in a user region 30U, and the second section A2 has a larger deterioration degree than any of the subpixels in the user region 30U; here, the user region 30U is a region of the display unit 30 excluding the first section A1 and second section A2.

### Fifth Embodiment

FIG. 16 is a side view of the configuration of the display device according to a fifth embodiment. As illustrated in FIG. 16, an openable-and-closable light-blocking window 70 may be provided on the viewing side of the first section A1. In this case, the window 70 may be opened while the user is making a comparison between a reference display and a sample display, and the window 70 may be closed during the other periods. The window 70 may be opened or closed through sliding. Providing the window 70 can prevent deterioration of the first section A1, in which the reference display is presented. The second section A2, which desirably has an environment similar to that of the display unit 30, may be provided with no window if the display unit 30 is exposed.

### Sixth Embodiment

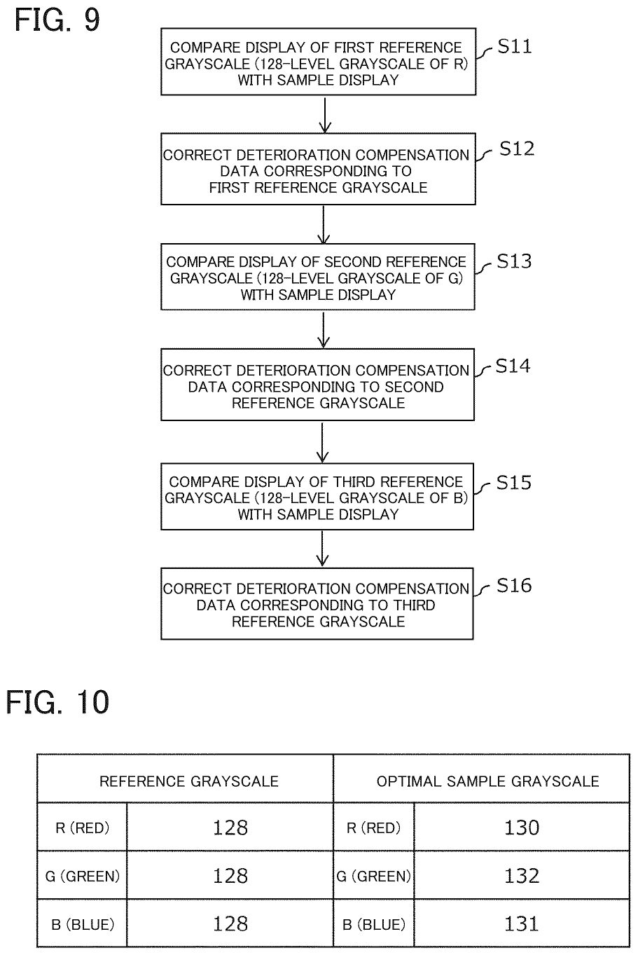

FIG. 17 is a schematic diagram illustrating the configuration of the first section according to a sixth embodiment, and the configuration of the second section according to the sixth embodiment. As illustrated in FIG. 17, the first section A1 may be shaped in a character, a mark (e.g., a brand mark), or a figure, and the second section A2 may have a shape constituting the background of the character, mark, or figure shown in the first section A1. Alternatively, the second section A2 may be shaped in a character, a mark, or a figure, and the first section A1 may have a shape constituting the background of the character, mark, or figure shown in the second section A2. The first section A1 and second section A2 in FIG. 17 may be provided inside the perimeter of the display unit 30.

### Seventh Embodiment

The display device 10 according to the first to sixth embodiments may be provided inside a mobile object. Possible examples of the mobile object include the following: vehicles, such as cars, trains, motorcycles, and bicycles; ships; and flying objects, such as planes, rockets, and satellites.

The foregoing embodiments are illustrative and descriptive rather than restrictive. It will be apparent for one of ordinary skilled in the art that various modifications can be made based on these examples and descriptions.

Reference Signs List

| | |
|---|---|
| 10 | display device |
| 30 | display unit |
| 40 | drive unit |
| 50 | control unit |
| 70 | window |
| A1 | first section |
| A2 | second section |
| DA | input data |
| DS | output data |
| DF | deterioration compensation data |

1. A display device provided with a display unit including a plurality of subpixels, and a control unit configured to generate output data in accordance with input data and deterioration compensation data, the display device comprising:
a first section in which a predetermined low grayscale is displayed or hidden during a period of video display on the display unit; and
a second section in which a predetermined high grayscale is displayed during the period of video display on the display unit,
wherein the control unit corrects the deterioration compensation data in accordance with a result of a comparison between a first reference display with a first reference grayscale displayed in the first section, and a sample display with at least one sample grayscale displayed in the second section.

2. The display device according to claim 1, wherein the deterioration compensation data is data for associating, for an individual input grayscale indicated by the input data, a stress value corresponding to a display history with a compensation grayscale.

3. The display device according to claim 2, wherein the control unit stores the stress value for the display unit, the stress value for the first section, and the stress value for the second section.

4. The display device according to claim 2, wherein the control unit generates the output data by using the input grayscale, and a compensation grayscale corresponding to the input grayscale.

5. The display device according to claim 1, wherein the predetermined low grayscale is a minimum grayscale, and the predetermined high grayscale is a maximum grayscale.

6. The display device according to claim 1, wherein the result of the comparison is input from a user who has visually compared the first reference display with the sample display.

7. The display device according to claim 1, wherein the control unit corrects the deterioration compensation data in accordance with a result of a comparison between the first reference display, and a plurality of sample displays with a plurality of sample grayscales displayed in the second section.

8. The display device according to claim 7, wherein the control unit corrects the deterioration compensation data in accordance with a grayscale difference between one of the plurality of sample grayscale at which one of the plurality of sample display that is the closest to the first reference display is obtained, and the first reference grayscale.

9. The display device according to claim 7, wherein the plurality of sample grayscales include the first reference grayscale, and a grayscale higher than the first reference grayscale.

10. The display device according to claim 8, wherein the display device corrects the deterioration compensation data when the grayscale difference is different from a compensation grayscale in the deterioration compensation data, and the display device does not correct the deterioration compensation data when the grayscale difference is equal to the compensation grayscale.

11. The display device according to claim 7, wherein the display device displays the plurality of sample grayscales in the second section at time intervals.

12. The display device according to claim 1, wherein the control unit corrects the deterioration compensation data in accordance with a result of a comparison between a second reference display with a second reference grayscale displayed in the first section, and a sample display with one or more other sample grayscales displayed in the second section.

13. The display device according to claim 12, wherein the one or more other sample grayscales include the second reference grayscale, and a grayscale higher than the second reference grayscale.

14. The display device according to claim 1, wherein
the plurality of subpixels exhibit a plurality of emission colors, and
the deterioration compensation data is prepared for each of the plurality of emission colors.

15. The display device according to claim 14, wherein the display device includes a period for presenting a first-colored first reference display and a first-colored sample display, a period for presenting a second-colored first reference display and a second-colored sample display, and a period for presenting a third-colored first reference display and a third-colored sample display.

16-22. (canceled)

23. The display device according to claim 1, comprising an openable-and-closable window provided on a viewing side of the first and second sections.

24. The display device according to claim 1, wherein the display unit, the first section, and the second section are formed on an identical pixel circuit substrate.

25. The display device according to claim 1, wherein the first reference grayscale is either a middle grayscale among all input grayscales that are possibly indicated by the input data, or a grayscale adjacent to the middle grayscale.

26. The display device according to claim 1, wherein each of the plurality of subpixels includes either an organic light-emitting layer or a quantum-dot light-emitting layer.

27. The display device according to claim 1, wherein the display device is provided inside a mobile object.

28. (canceled)
